(19) United States
(12) Patent Application Publication
(10) Pub. No.: US 2008/0114678 A1
(43) Pub. Date: May 15, 2008

(54) METHOD AND APPARATUS FOR REMOTE AUTHORIZATION

(76) Inventors: David Lawrence Bennett, Raleigh, NC (US); Daniel Leroy Hopping, Raleigh, NC (US); Thomas Joseph Prorock, Raleigh, NC (US); Thomas Guthrie Zimmerman, Cupertino, CA (US)

Correspondence Address: DUKE W. YEE;YEE & ASSOCIATES, P.C., P.O. BOX 802333, DALLAS, TX, 75380, US

(21) Appl. No.: 11/560,204

(22) Filed: Nov. 15, 2006

(51) Int. Cl. G06Q 20/00

(52) U.S. Cl. 705/44

(57) ABSTRACT

A computer implemented method, apparatus, and computer usable program product for managing remote authorization of transactions. The process suspends a transaction at a first location in response to detecting the occurrence of an override condition. The process then sends a request for authorization to a user operating a remote computing device at a second location to form a requested authorization. The remote computing device includes a verification device for capturing a requested authorization provided by the user of the remote computing device. The process then receives the requested authorization from the user of the remote computing device in response to sending the request. The process then authenticates the requested authorization in response to receiving the requested authorization, and allows the completion of the suspended transaction if the requested authorization is authenticated.

### BACKGROUND OF THE INVENTION

1. Field of the Invention

The present invention relates generally to an improved data processing system and in particular to authorizations. Still more particularly, the present invention is related to a computer implemented method, apparatus, and computer usable program product for providing remote authorization for transactions.

2. Description of the Related Art

Employees of a company have differing duties and responsibilities based upon a number of different factors, such as education, expertise, or experience. Certain employees, managers and supervisors for example, may be given the authority to make or authorize decisions on behalf of the company. Each of these decisions can be made with respect to transactions occurring during the course of business. A transaction is a communicative action, activity, or process involving two or more parties or things that reciprocally affect or influence each other. For example, a retail transaction may be the sale of a car, and a decision relating to the sale of the car may be a sales manager's approval of a final sales price to a potential buyer. Transactions may also be entirely unrelated to retail applications for the sale or exchange of items or services. For instance, an office manager or human resource director may be required to authorize employee vacation time, requests for paid leave, requests for maternity leave, or the disbursement of year-end bonuses. Similarly, a manager overseeing a company's supply chain functions may be required to authorize the receipt of merchandise from a distributor.

As with the examples presented above, many transactions are initiated, conducted, and terminated at a single location, and usually under a time constraint. This physical location can be considered a point of transaction. In a retail transaction, such as for the sale of a car, the point of transaction is commonly known as the point of sale. At the point of transaction, the customer and sales representative are often seated in an office attempting to negotiate a selling price. To the extent that a manager's approval is necessary to authorize the final offering price, the sales representative leaves the point of transaction, obtains a manager's authorization, and then returns to the point of transaction with the manager's decision.

In some instances, in order for a manager to provide authorization for a transaction occurring at a point of transaction, the manager is required to be physically located at the point of transaction. In addition, the manager may be required to present a form of identification before the authorization can be provided. The means of identification can include, for example, inputting a username and password or a user ID, turning a physical key, swiping an ID card, presenting an ID device or badge, or any similar known or available method for establishing identification. Each of these methods, however, has associated with it undesirable aspects.

For example, with respect to usernames and passwords, security concerns may require that passwords be periodically altered. A manager may forget the latest password, thereby preventing that manager from performing the required tasks and providing requested authorizations. Instead, the manager may decide to write down the password. However, the written information may be lost, or may be found and used by an unauthorized individual. Alternatively, a manager may pick simple, easy to remember passwords that are equally easy to guess. A manager may also recycle passwords in a predictable manner which may facilitate unauthorized access. Further, a security protocol at the point of transaction may lock a manager's account if a manager or an unauthorized party attempts, incorrectly, to enter the manager's password in excess of a predetermined limit. A manager may be prevented from performing job functions until the account is reset. Further, the resetting of the manager's account may be a time consuming and costly operation.

The use of a swipe card in conjunction with a magnetic card reader presents additional problems. The card may be demagnetized or erased by hardware used for processing retail transactions. In addition, swipe cards can be easily duplicated, stolen, or lost. Similarly, a security/ID badge can be stolen or lost. Replacing the security/ID badge can be costly and time consuming. Likewise, a physical key can be easily lost, stolen, or duplicated.

The current methods available for establishing the identity of a user, such as a manager, can be burdensome and time consuming, especially given the fact that the current methods of identity verification require the manager to be physically present at the point of transaction. For example, managers of large retail environments having numerous points of sale locations spread out over a large area, such as a mall full of movable kiosks and displays, spend a disproportionate amount of time in transit between the various points of sale to provide the requested authorization for retail-related transactions. As a result, sales transactions are needlessly delayed, causing customer dissatisfaction and a possible decrease in sales revenue. Additional managers or points of sale operators with the ability to authorize certain transactions can be provided. However, hiring additional managers is costly in terms of salaries and the increased cost of managing the additional managers. Further, providing point of sale operators with the ability to authorize transactions is risky given that these employees may lack the training, education, business sense, or loyalty to the company to make the proper decisions.

The proposed solutions for addressing the need for managers and supervisors to be physically located at a point of transaction in order to provide the requested authorization, as discussed above, can be costly and have undesirable risks and consequences.

### BRIEF SUMMARY OF THE INVENTION

The illustrative embodiments described herein provide a computer implemented method, apparatus, and computer usable program product for managing remote authorization of transactions. The process suspends a transaction at a first location in response to detecting the occurrence of an override condition. The process then sends a request for authorization to a user operating a remote computing device at a second location to form a requested authorization. The remote computing device includes a verification device for capturing an authorization provided by the user of the remote computing device. The process then receives the requested authorization from the user of the remote computing device in response to sending the request. The process then authenticates the requested authorization in response to receiving the requested authorization and allows the completion of the suspended transaction if the requested authorization is authenticated.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a networked data processing system in which illustrative embodiments may be implemented;

FIG. 2 is a block diagram of a data processing system in which the illustrative embodiments may be implemented;

FIG. 3 is a block diagram illustrating a system for providing remote authorization in accordance with an illustrative embodiment;

FIG. 4 is a block diagram of a verification device in accordance with an illustrative embodiment;

FIG. 5 is a sample database entry in which details relating to a requested authorization are stored in accordance with an illustrative embodiment;

FIG. 6 is a display for the presentation of stored transactions in accordance with an illustrative embodiment;

FIG. 7 is a flowchart illustrating a process for requesting authorization from a user located remotely to the point of transaction to complete a suspended transaction in accordance with an illustrative embodiment;

FIG. 8 is a flowchart illustrating a process for managing requests for authorization in accordance with an illustrative embodiment; and

FIG. 9 is a flowchart illustrating a process for providing a requested authorization from a remote computing device located remotely to the point of transaction in accordance with an illustrative embodiment.

### DETAILED DESCRIPTION OF THE INVENTION

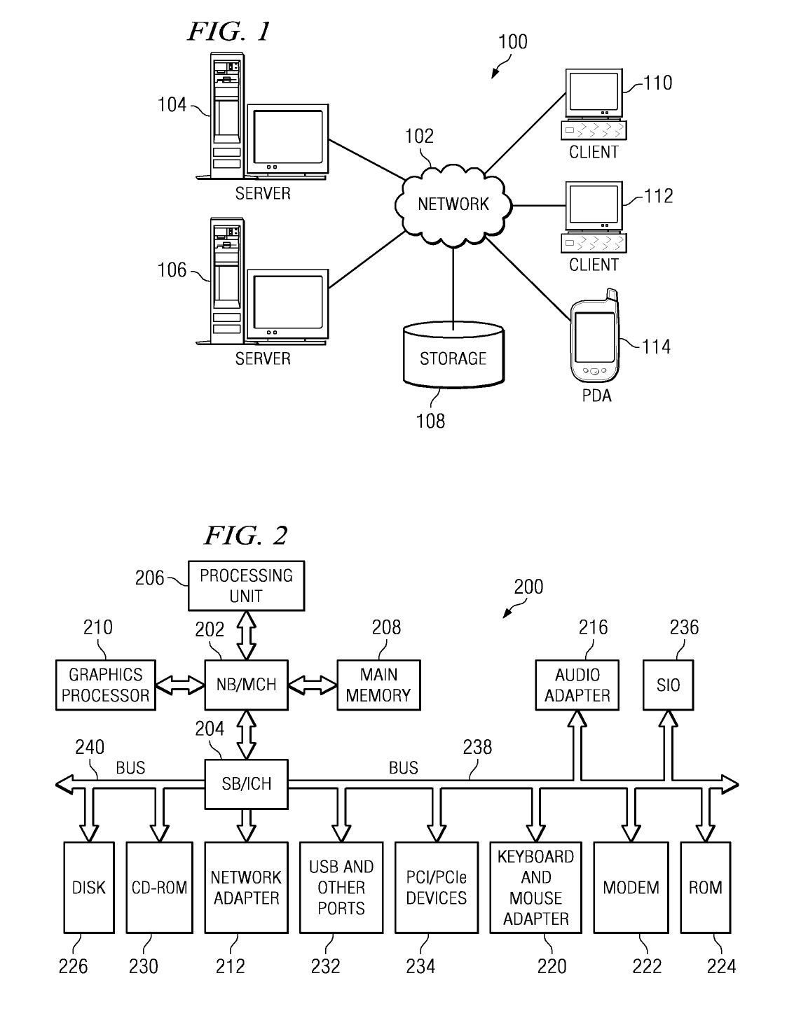

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a networked data processing system in which illustrative embodiments may be implemented. Networked data processing system 100 is a network of computing devices in which embodiments may be implemented. Networked data processing system 100 contains network 102, which is the medium used to provide communication links between various devices and computers connected together within networked data processing system 100. Network 102 may include connections, such as wire, wireless communication links, or fiber optic cables. The depicted example in FIG. 1 is not meant to imply architectural limitations. For example, networked data processing system 100 also may be a network of telephone subscribers and users.

In the depicted example, server 104 and server 106 connect to network 102 along with storage unit 108. In addition, client 110, client 112, and PDA 114 are coupled to network 102. Client 110, client 112, and PDA 114 are examples of devices utilized for sending and receiving data related to or embodying authorizations exchangeable in networked data processing system 100. For example, an authorization can comprise a handwritten signature, a fingerprint, a retinal scan, or a voice pattern converted into digital form that is subsequently transmitted between PDA 114 and client 110 or server 106 via network 102.

Client 110 and client 112 may be, for example, a personal computer, laptop, tablet PC, or network computer. Personal digital assistant (PDA) 114 may be any form of personal digital assistant, such as Palm OS®, Windows Mobile® Pocket PC®, Blackberry®, or other similar handheld computing device now known or later developed, such as a future generation iPod® having analogous functionality, or mobile communications device, such as a cellular telephone. In the depicted example, server 104 provides data, such as boot files, operating system images, and applications to client 110, client 112, and PDA 114. Client 110, client 112, and PDA 114 are coupled to server 104 in this example. Networked data processing system 100 may include additional servers, clients, PDAs, and other computing devices not shown.

In the depicted example, networked data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, networked data processing system 100 also may be implemented as a number of different types of networks, such as for example, an intranet, a local area network (LAN), a wide area network (WAN), a telephone network, or a satellite network. FIG. 1 is intended as an example and not as an architectural limitation for different embodiments.

With reference now to FIG. 2, a block diagram of a data processing system is shown in which illustrative embodiments may be implemented. Data processing system 200 is an example of a computing device, such as server 104, client 110, or PDA 114 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processing unit 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) and other communications ports 232, and PCI/PCIe devices 234 are coupled to south bridge and I/O controller hub 204 through bus 238. Hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP. (Microsoft and Windows are trademarks of Microsoft Corporation in the United States, other countries, or both.) The operating system may also be a retail specific operating system, such as IBM® 4690 Operating System®. An object-oriented programming system, such as the Java™ programming system, may run in conjunction with the operating system and provides calls to the operating system from Java programs or applications executing on data processing system 200. (Java and all Java-based trademarks are trademarks of Sun Microsystems, Inc. in the United States, other countries, or both.)

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments described herein provide a computer implemented method, apparatus, and computer usable program product for managing remote authorization of transactions. In one embodiment, the process suspends a transaction at a first location in response to detecting the occurrence of an override condition. The process then sends a request for authorization to a user operating a remote computing device at a second location to form a requested authorization. The remote computing device includes a verification device for capturing an authorization provided by the user of the remote computing device. The process then receives the requested authorization from the user of the remote computing device in response to sending the request. The process then authenticates the requested authorization in response to receiving the requested authorization and allows the completion of the suspended transaction if the requested authorization is authenticated.

In an illustrative embodiment, the transaction is a retail transaction. As used herein, a retail transaction is a sale or exchange of items, such as groceries, clothing, jewelry, sporting goods, pets, equipment, appliances, tools, books, music, movies, gift cards, beverages, drugs/prescription medications, or any other type of merchandise, goods, products, or items bought, sold, or offered for sale. A retail transaction can also include the sale or exchange of services, such as a car wash, carpet cleaning, delivery and installation of appliances, or any other services bought, sold, or offered for sale.

With a retail transaction, the point of transaction is the point of sale where the transaction is initiated, conducted, and/or terminated. The point of sale can be a checkout counter in a grocery store or any other location where a transaction occurs, such as a register located at a movable kiosk display in the mall. A point of sale comprises hardware and software. Point of sale hardware may include, for example, a cash register or computer performing similar tasks, a touch screen monitor, a pin pad, a magnetic card reader, a receipt printer, and a barcode scanner.

A remote computing device is a device operable by a user to receive and/or send information relating to a suspended transaction. The remote computing device may be a PDA, a tablet personal computer, a magnetic card reader, a pin-pad, a cash register, or any other device that can perform analogous functions. The information relating to a suspended transaction may include a digital signature, the approval or denial of the transaction, queries relating to the suspended transaction, the date and time of the transaction, the identities of the parties to the transaction, or any other similar information. The remote computing device is located at a second location different from the first location that serves as the point of transaction. For purposes of further distinguishing the first location and the second location, the second location can be considered a point of authorization as this is the location at which a manager receives a request for authorization and provides the requested authorization. As used herein, a manager may also be a supervisor or other employee having the responsibility and permission to authorize transactions.

For example, referring back to the example wherein an operator of a point of sale at a retail store seeks authorization from a manager to complete a transaction for the sale of an appliance at a discounted price, the point of transaction is the checkout counter at which the customer is completing the sale. The second location, also known as the point of authorization, is any location from which the requested authorization is provided. Thus, in this example, the second location can be a second point of sale that is located on the same floor as the point of transaction.

In addition, the second location can be a point of sale or other stationary computing terminal located on a different floor or in a different building from the point of transaction. In one embodiment, the second location is the manager's house, and the remote computing device is the manager's personal computer.

A verification device can be a separate device coupled to the remote computing device, or a component of the remote computing device. The verification device is a device that captures an authorization provided by the user of the remote computing device. The captured authorization may comprise, for example, a biometric identifier and the approval or denial of a transaction. A biometric identifier is a personal characteristic of an individual that serves to identify that individual. Examples of biometric identifiers include a fingerprint, a voice pattern, a retinal scan, or a handwritten signature.

In one embodiment, the verification device is a signature capture device that is capable of transforming the movement of a stylus or other writing instrument into a digital form usable by a dynamic signature verification technology to verify the signer's signature signing properties. In other embodiments, a verification device can comprise a fingerprint scanner, a voice capture device, or a retinal scanner.

A signature capture device can take the form of, but is not limited to, resistive films, capacitive electrodes, magnetic coils, membrane arrays, or ultrasonic, optical and other known or available sensing technologies capable of collecting a signer's digital signature and the signature's signing properties. In this example, the remote device is a PDA, and the signature capture device is the integrated display screen capable of capturing written information.

Signature signing properties are the unique ways in which a person generates a signature. Signature signing properties include such properties as the height and width of letters and pen strokes, the velocity of the writing instrument, pressure applied to the writing instrument, and rates of acceleration of the writing instrument. Signature signing properties can be embodied as data described by mathematical algorithms that can be stored and used for subsequent comparison. Because each individuals signature comprises unique signature signing properties, a comparison of a newly generated signature with a reference signature can serve as a means to authenticate a signature to verify the signer's identity. Thus, the generation of signatures can be considered a form of biometric identifier. Consequently, even though a signature may be forged to appear like an authentic signature, a comparison of the signature's signing properties with a reference signature's signing properties would yield the conclusion that the signature was fabricated by an imposter.

Dynamic signature verification technology can comprise software and/or hardware capable of capturing a written signature and performing a subsequent signature analysis. A signature analysis is the method by which a signature is authenticated. In the method of signature analysis, a recently captured signature and its associated signing properties are compared to a reference signature and a set of reference signing properties. If the captured signature falls within an acceptable range of variability, then the signature is deemed authentic. The method of signature analysis takes into account an acceptable range of signature variability because no two signatures generated by one individual are ever generated in the exact same way. However, each authentic signature shares important similarities and patterns that can still be used to verify the signer's identity. Authenticated signatures are used to provide a verified authorization. A verified authorization is the authorization that is provided by a manager, supervisor, or similarly situated employee having the authority to approve or deny a transaction. Signature analysis can be performed by any known or available dynamic signature verification technology and/or process.

In sum, the process allows for a manager located remotely from a point of transaction to receive an authorization request, and to remotely generate a requested authorization without the requirement of being physically present at the point of transaction. The requested authorization can be provided by a manager located remotely from the point of transaction by utilizing a remote computing device that is communicatively coupled to a computing device located at the point of transaction.

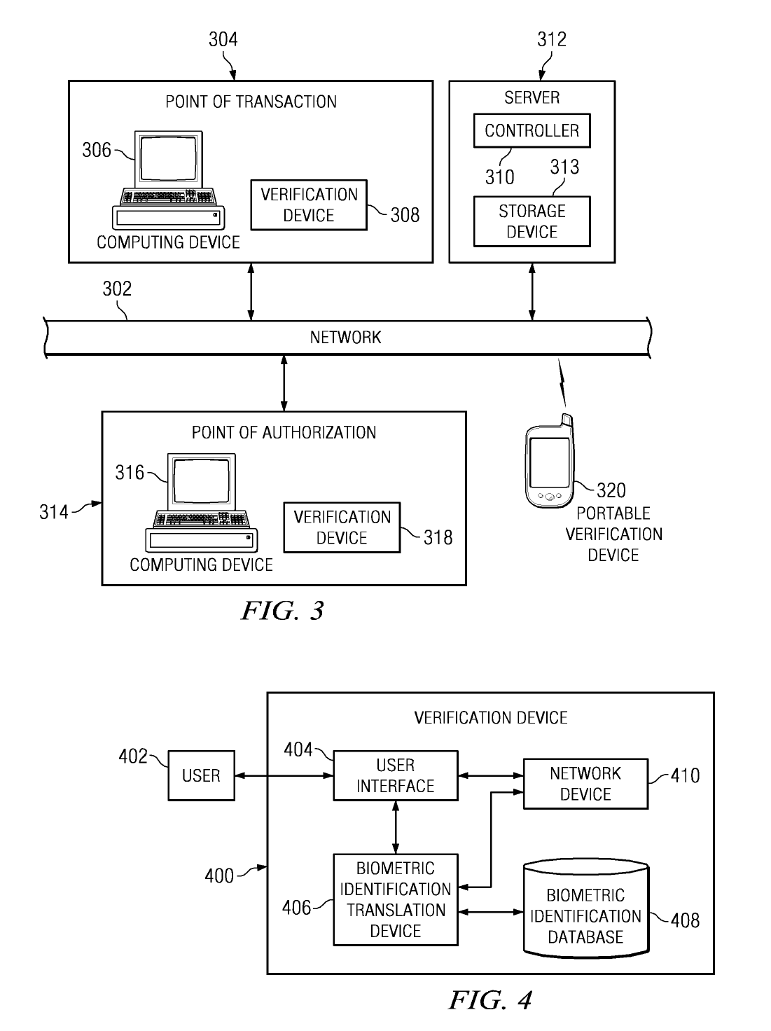

Turning now to FIG. 3, a more detailed diagram illustrating a network data processing system for managing the remote authorization of transactions is depicted in accordance with an illustrative embodiment.

Network 302 is a network, such as network 102 of FIG. 1, that serves as a medium for providing communications links between various devices and computers connected together in a network data processing system. Network 302 is coupled to point of transaction 304. Point of transaction 304 comprises computing device 306 and verification device 308.

An employee at point of transaction 304 utilizes computing device 306 for processing a transaction, such as a retail transaction for the sale of items, such as groceries, clothing, jewelry, sporting goods, pets, equipment, tools, books, music, movies, gift cards, beverages, drugs/prescription medications, or any other type of merchandise, goods, products, items, or services bought, sold, or offered for sale. Computing device 306 may comprise any number of additional components to facilitate the processing of the transaction. For the illustrative example in which computing device 306 is a cash register such as those registers found in a grocery store, computing device 306 may comprise a monitor to display the items as they are processed, input and output devices, such as a scanner, a numeric keypad, an electronic scale, a cash drawer, and a receipt printer. However, computing device 306 can also be a computer or any other known or available device, apparatus, or system for processing a transaction, such as a retail transaction occurring at a grocery store.

Processing the retail transaction may comprise scanning a barcode located on the item(s) for sale or weighing the item on an electronic scale, as in the case with produce and vegetables. In addition, the processing may include scanning coupons or rebates applicable for the purchased items. A list of the purchased items, their corresponding prices, and the amount of rebate, if any, are presented to the customer on a display located at point of transaction 304. The retail transaction is completed after the customer pays for the purchased items with for example cash, check, or a credit or debit card. In some cases, processing a retail transaction may include seeking a manager's authorization to complete the transaction in response to detecting an override condition.

An override condition is a condition that signals the suspension of the transaction at issue. The transaction cannot resume until after the system receives a requested authorization approving the transaction. Only then can the transaction be released for completion. With respect to a retail transaction, an override condition may be a preprogrammed condition that may include, but is not limited to: accepting a personal check to complete a transaction, accepting a payroll check as a means of payment, accepting a bill in excess of a specified denomination, detecting a sale of items in excess of an allowable amount, accepting coupons, detection of restricted sale items, such as alcohol and tobacco, or the detection of any special preprogrammed condition, such as an excessive number of voided items in a single transaction by a specific operator. However, an override condition can be any condition that is specifically tailored to the transaction at issue. Thus, override conditions relating to human resource-related transactions may include, for example, suspending a transaction for the authorization of vacation time in the event that no vacation days remain or suspending the disbursement of a year-end bonus in the event that the employee's work product fell below par for the preceding year.

When the user of verification device 308 is a customer, the customer swipes a credit or debit card through the card reader coupled to verification device 308. When prompted, the customer generates a signature on the user interface of verification device 308 with a stylus or other writing instrument in order to authorize payment to complete the retail transaction. When the user of verification device 308 is a manager of the retail store, the manager can utilize verification device 308 to generate a signature in order to provide a requested authorization for the transaction occurring at point of transaction 304.

To further illustrate the process wherein a manager provides a requested authorization in order to allow the completion of a suspended transaction, consider the preceding example of a retail transaction occurring at point of transaction 304 that is a point of sale within the retail store. In the simplest embodiment, a manager responding to a request for authorization provides the requested authorization in the form of the manager's signature generated at point of transaction 304. The manager can be notified of the suspended transaction and the necessary request for authorization by any means, including but not limited to, a call to the manager's cellular phone, PDA, or pager, a similar display generated on the manager's personal computer, or any other known or available device capable of receiving a similar notice. If the manager is in the vicinity of point of transaction 304, then the manager can generate the requested authorization by signing verification device 308 located at point of transaction 304.

Controller 310 is a software component implemented by server 312 that is coupled to network 302. Controller 310 is usable for sending a request for authorization, and for authenticating a requested authorization sent in response to the request for authorization. For instance, in an illustrative embodiment wherein the requested authorization includes a signature, controller 310 authenticates the requested authorization by performing a signature analysis on the manager's handwritten signature to verify the identity of the signer. In this example, where the requested authorization includes a manager's signature, controller 310 compares the captured signature's signing properties with a database of reference signature signing properties as described above. A matching signature indicates that the signer has the permission to authorize the suspended transaction.

If controller 310 can authenticate the requested authorization to establish that the signature is one of a set of signatures belonging to employees with permission to authorize the suspended transaction, then controller 310 permits the suspended transaction to continue. Controller 310 then archives the details of the transaction into a transaction log stored in storage device 313. A transaction log is a database containing details of the suspended transactions, which can include, but is not limited to, the date and time of the transaction, information identifying point of transaction 304 as the point of sale at which the transaction occurred, the item(s) serving as the basis of the retail transaction, the identity of the operator located at point of transaction 304, the customer's identity, the operator's name and/or identification number, the signature or other biometric identifier of the manager, and any other identifying information relating to the transaction.

In another illustrative embodiment where the requested authorization includes a fingerprint scan, controller 310 authenticates the requested authorization by first comparing a captured fingerprint pattern to a database of reference fingerprint patterns of employees having permission to authorize suspended transactions. The process proceeds similarly if the requested authorization includes a voice pattern, a retinal scan, or some other biometric identifier.

Although the illustrative embodiment presented above shows controller 310 as being implemented in server 312, in another embodiment controller 310 may be implemented in computing devices 306 and 316.

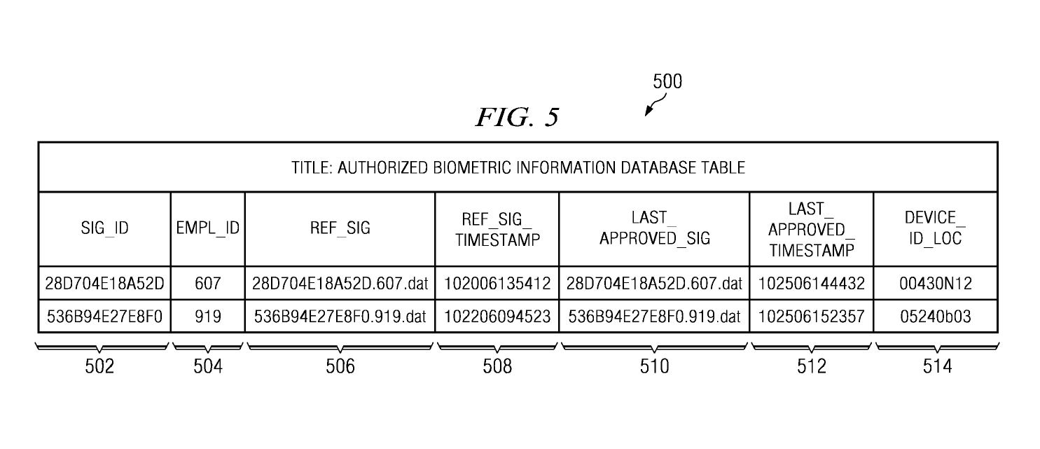

Upon releasing the suspended transaction for completion, controller 310 archives a record of the requested authorization in a transaction log for auditing or tracking purposes. The record can include, but is not limited to, any one or more of the following: a digital copy of the signature, data relating to the set of signature signing properties, such as the height and width of letters and pen strokes, the velocity of the writing instrument, the pressure applied to the writing instrument, and the rates of acceleration of the writing instrument, the date and time at which the requested authorization was provided, and the identity of the remote device from which the requested authorization was generated. An example of this database is provided in FIG. 5 below.

In another embodiment, a manager receives the request for authorization at point of authorization 314 that is coupled to network 302. Point of authorization 314 can be a different point of sale than the point of sale that also falls under the definition of point of transaction 304. Point of authorization 314 is a location different from point of transaction 304 at which a manager can receive an authorization request and generate the requested authorization by utilizing computing device 316 and verification device 318. As already discussed above, point of authorization 314 can be located on a different floor or in a different building from point of transaction 304. Additionally, point of authorization 314 can also be located at the manager's house.

Even though the manager is located at point of authorization 314 which is located remotely to point of transaction 304, the manager can still view a summary of the transaction occurring at point of transaction 304 by requesting that controller 310 display a remote view of the transaction on computing device 316 as it is seen by the employee at point of transaction 304. After reviewing the transaction, the manager can provide the requested authorization by signing verification device 318 and allowing controller 310 to perform the signature analysis as previously described above. Upon authenticating the manager's signature, controller 310 releases the suspended transaction for completion.

In another embodiment, the manager may receive the request for authorization while operating a remote computing device such as portable verification device 320. In this embodiment, the manager can request that controller 310 display a remote view of the transaction summary on the display area of portable verification device 320 which is capable of displaying textual or graphical information. In the alternative, the manager may request that controller 310 display the transaction summary on any display capable of presenting textual or graphical information, such as a projection screen, a video monitor, or the IBM® Everywhere Displays®. Upon review of the transaction, the manager may generate a signature on the area of portable verification device 320 capable of receiving handwriting samples.

Although not depicted in FIG. 3, server 312 may implement a software component comprising a web service using well known service oriented architecture (SOA) in order to find and display a list of suspended transactions. Service oriented architecture (SOA) is a software architecture that is a platform independent collection of web services centrally stored which are available to software applications and network end users. A web service is an interface that describes a collection of operations that are network accessible through standardized extensible markup language (XML) messaging. Web services fulfill a specific task or a set of tasks. A web service is described using a standard format extensible markup language notation called its service description, which provides all of the details necessary to interact with the service, including message formats, transport protocols, and location. Thus, in an illustrative embodiment, server 312 can implement a web service capable of retrieving a list of suspended transactions. In this manner, a manager operating a remote computing device, such as portable verification device 320, generates a request to view a list of suspended transactions. After the web service capable of retrieving the suspended transactions is located, the web service performs the necessary actions to retrieve the list of suspended transactions. The web service then presents the list of suspended transactions to a user operating a remote computing device, such as portable verification device 320.

In the event that a manager desires additional information prior to providing the requested authorization, a manager can generate handwritten or typed queries on portable verification device 320. Controller 310, for example, may provide an answer if the answer is known. For instance, consider the transaction suspended at point of transaction 304 because controller 310 detected an override condition. The override condition was a counterproposal to the listed price of an item on sale. The manager operating a remote computing device may have the authority to permit the sale of that particular item at a discounted price, but may not wish to authorize such a sale price until additional information about the item is known. In this example, a manager operating portable verification device 320 may generate a written request to controller 310, such as “number in inventory?”. Controller 310 could interpret this query and provide the manager, via portable verification device 320, the number of that item in inventory. Thus, if the inventory of the item shows that sales of that item are stagnant, then the manager may desire to authorize the sale of the item at the discounted price.

In another embodiment, the manager utilizing portable verification device 320 may send queries directly to an employee at point of transaction 304 for additional information relating to the retail transaction. For example, consider a customer at point of transaction 304 requesting a discounted price on a damaged item offered for sale. In response to viewing the transaction summary, the manager operating portable verification device 320 may send a query to the operator at the point of sale inquiring into the condition of the item in the following manner: “Item condition?” to which the operator could respond “Slightly damaged”. In this manner, the manager has sufficient information to provide the requested authorization to sell the item at a discounted price. In this example, as with the previous example, the details of the transactional authorization are written to a transaction log stored in a storage device, such as storage device 313 coupled to server 312.

Portable verification device 320 may perform the required signature analysis, and, pending signature verification, portable verification device 320 may communicate the authorization to server 312 and point of transaction 304. Portable verification device 320 can be a PDA, a tablet personal computer, or any other device capable of receiving a biometric identifier, such as a handwritten signature for signature analysis. In another embodiment, portable verification device 320 may transmit the captured signature and associated signing properties to a second device, such as server 312, for signature analysis. In this embodiment, server 312 can verify the manager's signature and allow the suspended transaction to continue by removing the suspension on the transaction and directing the employee at point of transaction 304 to complete the transaction.

Once the requested authorization has been provided, the details of the transactional authorization are archived in the transaction log stored in storage device 313 to permit subsequent review and auditing. The details of the transaction may include the date and time of the transaction, the point of transaction, the identity of the remote computing device from which the transactional authorization was provided, the subject matter of the transaction, the identity of the customer if the transaction is a retail sale, the operator's name and/or employee identification number, the signature of the manager, and any other identifying information relating to the transaction.

Referring now to FIG. 4, a block diagram of a verification device is shown in accordance with an illustrative embodiment. Verification device 400 is a device operable by a user, such as a manager, to capture a biometric identifier, such as a signature, in order to provide a requested authorization to release a suspended transaction. Verification device 400 may be a verification device such as verification devices 308 and 318 and portable verification device 320 in FIG. 3.

Verification device 400 is operated by user 402 interacting with user interface 404. User 402 can be any person, such as a supervisor, manager, or similarly situated employee who is permitted to provide a requested authorization to release a suspended transaction for completion. User interface 404 is any known or available type of user interface, including but not limited to, a touch screen, a graphical user interface (GUI), a keyboard, a mouse, an alphanumeric keypad, a voice recognition system, or any other type of user interface.

Verification device 400 also includes biometric identification translation device 406. Biometric identification translation device 406 implements software and/or hardware to capture the biometric identifier presented at user interface 404. In one embodiment, biometric identification translation device 406 utilizes dynamic signature verification software and/or hardware necessary to capture the signature generated at user interface 404 and convert the signature into a digital form for comparison with reference signatures stored in biometric identification database 408. Details of the transaction can be transmitted to a storage device, such as storage device 313 in FIG. 3, via network device 410. Network device 410 enables signature capture device 400 to interact with a point of transaction, a point of sale, data processing systems, remote printers, or storage devices through intervening private or public networks. Modems, cable modems, Ethernet cards, and wireless cards are just a few of the currently available types of network devices.

In another embodiment, the user authentication is performed in a device other than the verification device 400, such as in server 312 in FIG. 3. In this embodiment, user interface 404 and biometric identification translation device 406 work in conjunction to capture the movement of a stylus or other writing instrument in the event that verification device 400 is a signature capture device. The captured signature and associated signing properties are conveyed to server 312 for performing a signature analysis. Similarly, biometric identification database 408 may be stored in a device located remotely to verification device 400, such as in storage device 313 in FIG. 3.

Referring now to FIG. 5, a sample database entry in which details relating to a requested authorization are stored is depicted in accordance with an illustrative embodiment. Authorized biometric information database table 500 is a relational database that can be stored in a storage device, such as storage device 313 in FIG. 3. A relational database is a collection of one more tables. The one or more tables store information and are comprised of a number of rows, also known as records, and columns, also known as fields. Data contained within a record are related, in this illustrative example, to a single authorized signer. Examples of relational databases include, but are not limited to, IBM DB/2®, Apache Derby®, MySql®, and Oracle®.

As depicted herein, authorized biometric information database table 500 is formatted to store information relating to an embodiment wherein the method of biometric identification is a signature analysis. Authorized biometric information database table 500 contains a number of columns, the first of which may be SIG_ID 502. SIG_ID 502 stores the unique digital value derived from a signature's signing properties. Rather than storing all of a signature's signing properties, a calculated value of the signing properties is stored in SIG_ID 502. The calculated value of a signature's signing properties can be compared with the calculated value of subsequently generated signatures for authenticating a signer's identity. Thus, a newly generated signature that has signing properties with a numerical value that matches the record in SIG_ID 502 can serve to verify the identity of the signer.

In response to storing a reference signature's signing properties in SIG_ID 502, a unique number for identifying the owner of the signature and associated signing properties is stored in EMPL_ID 504. This data is stored during the initial signature registration process which can occur at any time by utilizing any verification device that implements dynamic signature verification software.

In these examples, REF_SIG 506 contains the names of the data files that store the digital image of the reference signature generated during the registration process. REF_SIG_TIMESTAMP 508 stores data relating to the date and time that the reference signature was created or updated.

LAST_APPROVED_SIG 510 stores the name of the file containing the last approval signature and the associated signature signing properties used in the most recent transactional authorization. LAST_APPROVED_TIMESTAMP 512 stores data relating to the date and time of the most recent authorization that was provided. DEVICE_ID_LOC 514 stores the location and/or identity of the remote computing device from which the most recent transactional authorization was provided. Such information may be used later for auditing, troubleshooting, or any other foreseeable reason.

For example, when the requested authorization includes a signature generated on a signature capture device, such as portable verification device 320 of FIG. 3, a component of the signature capture device, such as biometric identification translation device 406 of FIG. 4, generates a signature ID using the captured signature signing properties. Server 312 in FIG. 3 searches authorized biometric information database table 500 for a matching signature ID located in SIG_ID 502. A matching signature ID indicates that the employee providing the signature is permitted to provide the requested transactional authorization.

In this example, with each subsequently generated authorized signature that is matched with an entry in authorized biometric information database table 500, the system refines the reference signature's signing properties to take into account the minor variations of signing properties that exist in every signer's signature.

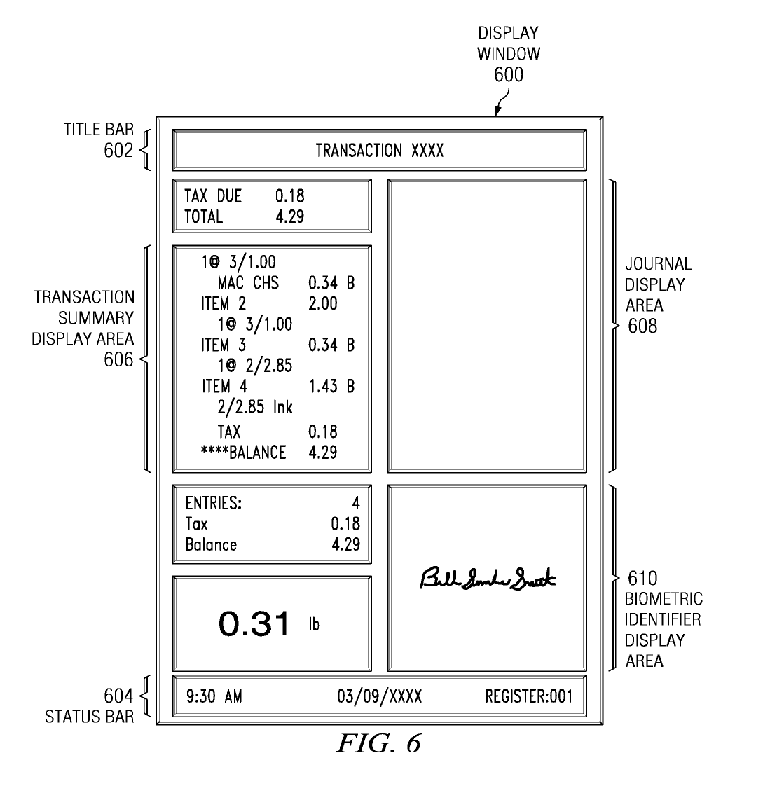

Referring now to FIG. 6, a display for the presentation of authorized transactions is shown in accordance with an illustrative embodiment. Display window 600 is a display for visually presenting details of a completed transaction for which authorization was required. Subsequent review of completed transactions may be necessary for purposes of review or audit.

Display window 600 can be presented to a user on a PDA, a tablet personal computer, a desktop computer, a video projector, or any other computing device capable of presenting visual and/or textual information. The information presented in display window 600 is stored in a database, such as a transaction log or authorized biometric identification database 500 of FIG. 5. An example of a computing device capable of presenting display window 600 includes PDA 114 of FIG. 1.

In the illustrative example depicted in FIG. 6, display window 600 is formatted to present information relating to a retail transaction. Further, the biometric identifier contemplated by this example is a signature generated at a signature capture device, such as PDA 114 of FIG. 1. In another illustrative embodiment, however, display window 600 can be customized for presenting information relating to non-retail transactions, such as those transactions relating to human resource functions or supply chain management. Further, the associated biometric identifier may be, for example, a fingerprint, a voice pattern, or a retinal scan.

Title bar 602 may identify the program responsible for generating display window 600 and may also identify the store at which the retail transaction occurred. Status bar 604 may be programmed to display the date and time of the transaction, the operator name and/or identification number, and the point of transaction. In the case of a retail transaction, status bar 604 would instead include the point of sale at which the transaction occurred.

Transaction summary display area 606 provides a scrollable list to present a detailed view of the transaction. In the event that display window 600 is used in conjunction with a retail transaction, transaction summary display area 606 may present a list of the items purchased and pricing information, as depicted. Similarly, if display window 600 is customized for a use relating to human resource transactions, transaction summary display area 606 may present, for example, an individual employee's employment history, such as start date, dates of raises and promotions, achievements and accolades, formal reprimands, and other similar information contained in an employee's personnel file.

Display window 600 may also include journal display area 608 that displays any manager-generated notes or entries relating to the transaction at issue. For example, with respect to the retail transaction involving the sale of a damaged item, transaction display area 606 may not indicate that the sold item was damaged. However, a manager authorizing the sale of the item may have input an entry detailing the item's condition.

Biometric identifier display area 610 may also be included in display window 600. Biometric identifier display area 610 displays the biometric identifier captured during the process of authorizing a suspended transaction. In this illustrative example, the biometric identifier is a handwritten signature. However, in other embodiments, biometric identifier display area 610 may present a captured fingerprint, an audio pattern representing a voice scan, or a retinal scan.

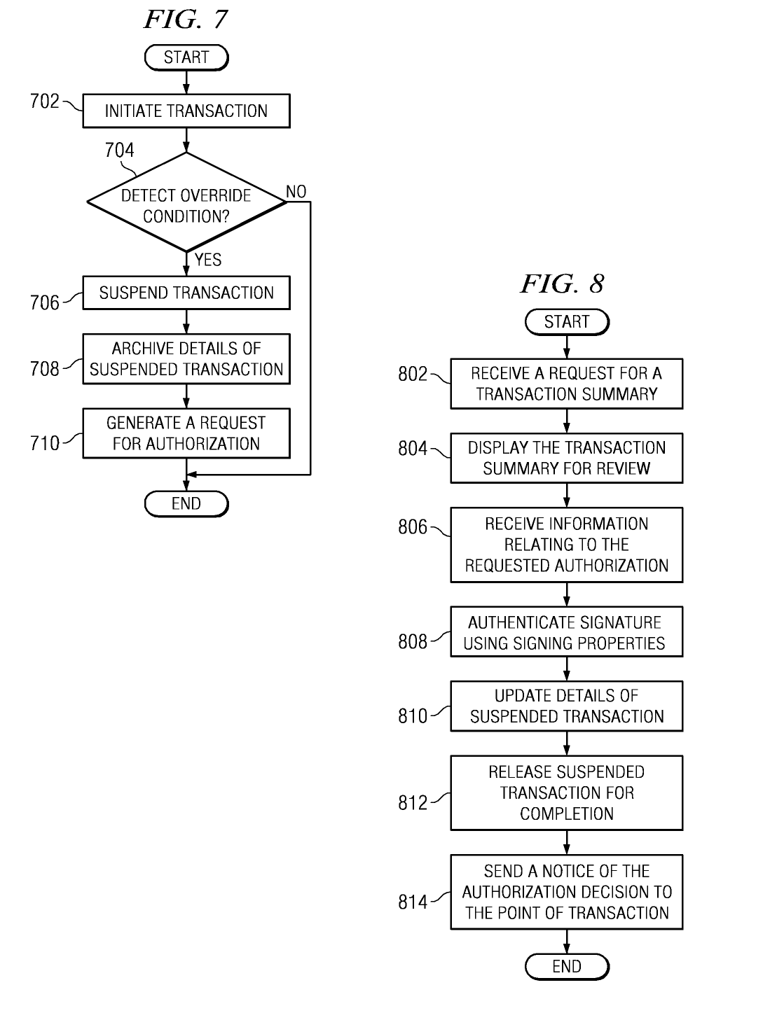

Referring now to FIG. 7, a flowchart of a process for requesting authorization from a user located remotely to the point of transaction to complete a suspended transaction is depicted in accordance with an illustrative embodiment. The process illustrated in this example is performed by a software component, such as controller 310 in FIG. 3.

The process begins when a transaction is initiated at a point of transaction, such as point of transaction 304 in FIG. 3 (step 702). The process makes the determination as to whether an override condition has been detected (step 704). In response to the detection of an override condition, the process suspends the transaction (step 706). The process then archives the details of the suspended transaction (step 708) and generates a request for authorization (step 710). The process terminates thereafter.

Returning to step 704, if the process fails to detect the occurrence of an override condition, then the process terminates thereafter.

Referring now to FIG. 8, a flowchart of a process for managing remote authorization of transactions is depicted in accordance with an illustrative embodiment. In this example, the process is performed by a software component, such as controller 310 in FIG. 3.

The process begins by receiving a request to present a transaction summary at a remote computing device, such as computing device 306, computing device 316, and portable verification device 320 in FIG. 3 (step 802). In response to receiving the request for a transaction summary, the process displays the transaction summary for user review on the remote computing device from which the request was generated (step 804).

Thereafter, the process receives information relating to the requested authorization generated at the remote computing device, such as the digital image of the signature, the signing properties associated with the digital signature, and the authorization decision either approving or denying the override condition (step 806).

The process then authenticates the signature and the associated signing properties using a reference signature and its signing properties in order to verify the identity of the signer as a person having permission to provide the requested authorization for the suspended transaction (step 808).

The process updates the details of the suspended transaction to include the final authorization decision as either approved or denied (step 810). The process then releases the suspended transaction for completion (step 812) and notifies the employee working at the point of transaction of the authorization decision (step 814). The process terminates thereafter.

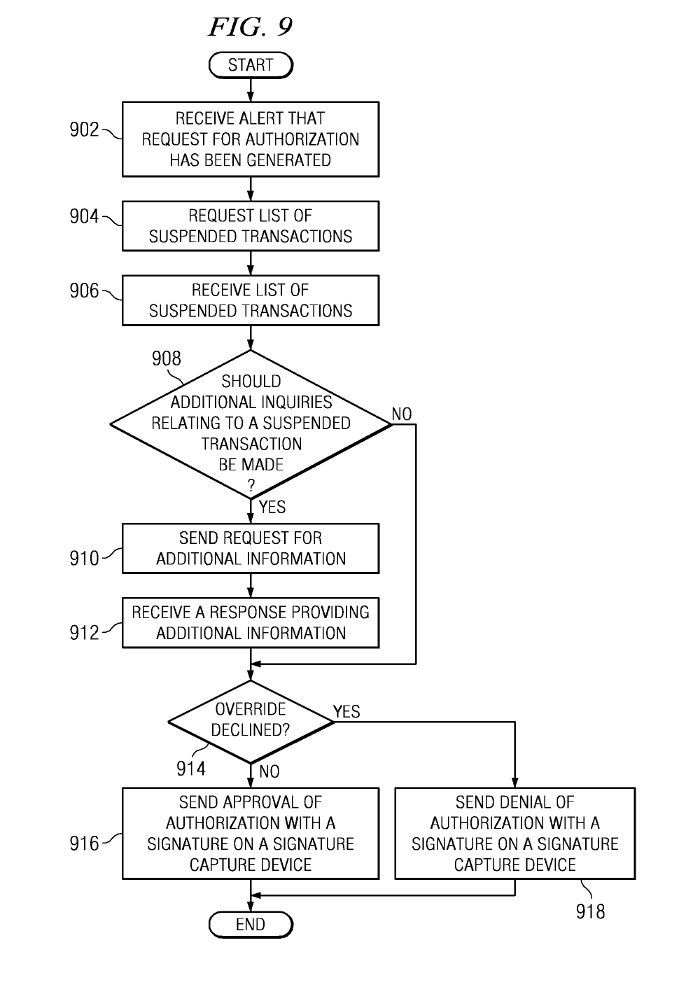

Referring now to FIG. 9, a flowchart of a process for providing a requested authorization from a remote computing device located remotely to the point of transaction is depicted in accordance with an illustrative embodiment. In this embodiment, the process is performed by a software component, such as controller 310 of FIG. 3.

The process begins by receiving an alert that a request for authorization has been generated (step 902). The process then requests a list of suspended transactions (step 904). In response, the process receives a list of suspended transactions (step 906).

The process then makes a determination as to whether additional inquiries relating to the suspended transaction have been made (step 908). In the event that additional information is requested, the process sends a request for additional information (step 910). Thereafter, the process receives a response to the request for the additional information (step 912).

The process then makes the determination as to whether the authorization declines the override (step 914). If the process makes the determination that the override is not declined, then the process sends the requested authorization in the form of an approval, along with the signature generated on a signature capture device (step 916). The process terminates thereafter. However, if the process determines that the transaction is declined, then the process sends the requested authorization in the form of a denial, along with the signature generated on a signature capture device (step 918). The process terminates thereafter.

Returning now to step 908, if the process makes the determination that no additional information relating to the suspended transaction is required, then the process proceeds directly to step 914.

Thus, the illustrative embodiments described herein provide a computer implemented method, apparatus, and computer usable program product for managing remote authorization for transactions. The process suspends a transaction at a first location in response to detecting the occurrence of an override condition. The process then sends a request for authorization to a user operating a remote computing device at a second location to form a requested authorization. The remote computing device includes a verification device for capturing an authorization provided by the user of the remote computing device. The process then receives the requested authorization from the user of the remote computing device in response to sending the request. The process then authenticates the requested authorization in response to receiving the requested authorization and allows the completion of the suspended transaction if the requested authorization is authenticated.

In a preferred embodiment, the authorization provided by the user of the remote computing device is the user's handwritten signature. The process verifies the requested authorization by performing a signature analysis utilizing dynamic signature verification technology. In response to verifying the signature, the process allows the suspended transaction to proceed to completion.

Using this method, the process can facilitate the management of remote authorization of transactions by allowing a user, such as a manager, supervisor, or similarly situated employee, from whom an authorization has been requested to quickly, effortlessly, and efficiently review and then approve or deny a transaction occurring at a point of transaction from a second location located remotely to the point of transaction. The use of a handwritten signature as a form of a biometric identifier obviates the need to implement current inefficient and burdensome methods of establishing an identity in order to authorize transactions, such as the presentation of a physical key, the swiping of a card through a magnetic card reader, or the inputting of a username and password or user ID. The use of signatures to establish a manager's identity is preferred because a signature is virtually unforgettable and is irreproducible by an individual who is not the true owner of the signature.

As described above, a transaction can be authorized without requiring the manager's physical presence at the point of transaction. Thus, the illustrative embodiments save customers time by not having to wait for a manager to arrive at the point of sale location. The illustrative embodiments also improve the manager's efficiency and the efficiency of other employees by permitting the manager/other employees to authorize transactions from any location.

Although many types of transactions exist, a discussion involving retail transactions in particular was provided in the illustrative embodiments set forth above. However, the illustrative embodiments are not limited to implementation in a retail environment or limited to application in retail transactions.

The flowchart and block diagrams in the figures illustrate the architecture, functionality, and operation of some possible implementations of systems, methods and computer program products according to various embodiments. In this regard, each block in the flowchart or block diagram may represent a module, segment, or portion of code, which comprises one or more executable instructions for implementing the specified logical function(s). It should also be noted that, in some alternative implementations, the functions noted in the block may occur in a different order than noted in the figures. For example, two blocks shown in succession may, in fact, be executed substantially concurrently or the blocks may sometimes be executed in the reverse order, depending upon the functionality involved.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, barcode scanners, touch screen displays, electronic scales, RFID readers, etc.) can be coupled to the system either directly or through intervening I/O controllers.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A computer implemented method for remotely approving a transaction, the computer implemented method comprising:
responsive to detecting an occurrence of an override condition during the transaction at a first location, suspending the transaction;
sending a request for authorization to a user operating a remote computing device at a second location to form a requested authorization, wherein the remote computing device comprises a verification device for capturing the requested authorization from the user;
responsive to receiving a query from the user, presenting additional information regarding the transaction, wherein the additional information is presented to the user on the remote computing device;
authenticating the requested authorization in response to receiving the requested authorization; and
allowing the transaction to proceed to completion if the requested authorization is authenticated.

2. The computer implemented method of claim 1, wherein the transaction is a retail transaction.

3. The computer implemented method of claim 1, wherein the requested authorization is a signature generated at the remote computing device.

4. The computer implemented method of claim 1, wherein the verification device is a signature capture device.

5. The computer implemented method of claim 1, wherein the verification device is a fingerprint scanner, and wherein the requested authorization is a fingerprint entered at the remote computing device.

6. The computer implemented method of claim 1, further comprising:
responsive to a completed transaction, storing a record of the requested authorization in a transaction log, wherein the record includes at least one of a signature and a set of signature signing properties.

7. The computer implemented method of claim 1 further comprising:
responsive to receiving the authorization request at the second location, presenting on a display of the remote computing device a summary of the transaction occurring at the first location; and
generating the requested authorization in the remote computing device located remotely to the first location.

8. The computer implemented method of claim 7, wherein the display further comprises at least one of a first area for presenting textual data and a second area for receiving handwritten data.

9. The computer implemented method of claim 8, wherein the textual data is at least one of a transaction summary and a response to a query generated from the remote computing device.

10. The computer implemented method of claim 8, wherein the handwritten data is at least one of a query generated by a user utilizing the remote computing device and a signature of the user of the remote computing device.

11. A computer program product comprising a computer usable medium having computer usable program code for remotely approving a transaction, the computer program product comprising:
computer usable program code for suspending a transaction responsive to detecting an occurrence of an override condition during a transaction at a first location;
computer usable program code for sending an authorization request to a user operating a remote computing device at a second location to form a requested authorization, wherein the remote computing device comprises a verification device for capturing the requested authorization from the user;
computer usable program code for presenting additional information regarding the transaction to the user in response to receiving a query from the user, wherein the additional information is presented to the user on the remote computing device;
computer usable program code for authenticating the requested authorization in response to receiving the requested authorization; and
computer usable program code for allowing the transaction to proceed to completion if the requested authorization is authenticated.

12. The computer program product of claim 11, wherein the requested authorization is a signature generated at the remote computing device.

13. The computer program product of claim 11, wherein the requested authorization is a fingerprint generated at the remote computing device.

14. The computer program product of claim 11, further comprising:
computer usable program code for storing a record of the requested authorization in a transaction log responsive to a completed transaction, wherein the record of the requested authorization includes at least one of a signature and a set of signature signing properties.

15. The computer program product of claim 11, further comprising:
computer usable program code for presenting on a display of the remote computing device a summary of the transaction occurring at the first location responsive to receiving the authorization request at the second location; and
computer usable program code for generating the requested authorization in the remote computing device located remotely to the first location.

16. A system comprising:
a bus;
a communications unit connected to the bus;
a memory connected to the bus wherein the memory includes a set of instructions; and
a processing unit connected to the bus, wherein the processing unit executes the set of instructions to suspend a transaction at a first location responsive to detecting an override condition, sends a request for authorization to a user operating a remote computing device at a second location to form a requested authorization, presents additional information regarding the transaction to the user in response to receiving a query from the user, wherein the additional information is presented to the user on the remote computing device, authenticates the requested authorization in response to receiving the requested authorization, and allows the transaction to proceed to completion if the requested authorization is authenticated.

17. The system of claim 16 further comprising a remote computing device, wherein the remote computing device comprises a visual display further comprising:
at least one of a first area for presenting textual data and a second area for receiving handwritten data.

18. The system of claim 17, wherein the textual data is at least one of a transaction summary and a response to a query generated from the remote computing device.

19. The system of claim 17, wherein the handwritten data is at least one of a query generated by a user utilizing the remote computing device and a signature of the user utilizing the remote computing device.

20. The system of claim 17, wherein the remote computing device is at least one of a personal digital assistant, a tablet personal computer, a magnetic card reader, and a pin-pad.
